(19) United States
(12) Patent Application Publication
(10) Pub. No.: US 2008/0057320 A1
(43) Pub. Date: Mar. 6, 2008

(54) HEALTHCARE DEVICE

(75) Inventor: Masakazu KOMURO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NAC CO., LTD., Setagaya-ku (JP)

(21) Appl. No.: 11/765,164

(22) Filed: Jun. 19, 2007

(30) Foreign Application Priority Data
Sep. 6, 2006 (JP) 2006-241359
Nov. 16, 2006 (JP) 2006-310049
Dec. 4, 2006 (JP) 2006-327210

(51) Int. Cl. B32B 33/00

(52) U.S. Cl. 428/426; 428/688

(57) ABSTRACT

A healthcare device is provided whereby the human body is continuously penetrated by infrared radiation and charged particles when the device is being worn, so as to provide health promotion effects. Composite carbon particles having an SP3 diamond structure and an SP2 graphite structure are disposed at a human body contact face of a healthcare device. Continuous infrared radiation and charged particle penetration effects are produced, resulting in superior blood circulation and body temperature rise. Furthermore, a material made by mixing carbon particles having an SP3 diamond structure and resin or glass bond is applied as a coating on a piezoelectric/pyroelectric material. As a result of excitation of the piezoelectric/pyroelectric material, the continuous infrared radiation and charged particle penetration effect of the SP3 carbon particles is amplified, so that the amount of the SP3 carbon particles used can be reduced, which is economical.

### TECHNICAL FIELD

The present invention relates to a healthcare device that provides a health-promoting effect as the result of being worn in contact with the body and penetrating the human body with magnetic force lines, infrared radiation and charged particles.

### BACKGROUND ART

The following are known as healthcare devices that are worn in contact with the body and provide a health-promoting effect.

### Use of Magnetic Force Lines

In order to take advantage of the blood circulation promoting effect of magnetic force lines on the human body, it is common for magnetic materials to be made into chips, which are affixed to the human body with adhesive tape or the like, and used as healthcare devices. Ferrite magnets with (BH)ₘₐₓ values of approximately 3 and alnico metal magnets with (BH)ₘₐₓ values of approximately 5 to 10 are used for the magnets and, recently, high energy product rare earth magnets reaching (BH)ₘₐₓ values as high as 10 to 30 are in use.

### Use of Infrared Radiation

Infrared radiation has also been found to have a blood circulation promoting effect, a nerve fiber activating effect, an analgesic effect and the like. As with magnets, chips are fabricated and used as healthcare devices. Infrared radiation emitting materials which are in use range from germanium, which releases far infrared radiation at wavelengths of approximately 100 μm, to tourmaline, which releases infrared radiation at wavelengths of 10 to 15 μm, and the like.

### Use of Charged Particles

Furthermore, charged particles, which are generated by activating piezoelectric/pyroelectric materials such as tourmaline by body heat, are coming into use, as they have been found to have a muscle fatigue relieving effect and an analgesic effect as a result of penetrating the human body.

### Composite Magnets

Recently, because the actions and effects of magnetic force lines alone or infrared radiation alone are limited, composite magnets have been devised, comprising a magnetic material and an infrared radiation emitting material that has a piezoelectric/pyroelectric effect, so as to produce a synergistic effect from magnetic force lines, infrared radiation and charged particles (for example, see JP-05-347206-A).

Furthermore, tourmaline emits infrared radiation from energy levels of 0.1 to 0.4 eV at wavelengths of 4 to 10 μm, which has a great heating effect, but because it is an insulator, the level density is low, so the number of excited carriers is small, and it is not possible to sufficiently maintain infrared radiation levels with the level of thermal excitation found at body temperature. Furthermore, piezoelectric/pyroelectric materials such as tourmaline are electrical insulators, and therefore the number of excited charged particles is small, so that the charged particles that are generated, which are accelerated by an electrical field, have little mobility within the object, and little charged particle penetration effect can be expected.

Furthermore, germanium has a small band gap of approximately 0.6 eV, and infrared radiation released from the impurity level of 0.01 eV is primarily in the 100 μm wavelength range, which is thought to penetrate the body at a deep level and is in use. However, as indicated by Wien's displacement law, infrared radiation at a wavelength of 100 μm, which is near that of infrared radiation released from extremely cold objects at approximately 30° K, has little heating effect, and it is thought that the actions and effects are primarily due to the effect of penetration by charged particles resulting from thermal excitation due to body heat.

For composite magnets, which are manufactured in order to achieve a synergistic effect from the effects of the charged particles, the infrared radiation and the magnetic force lines, and which are fabricated by press molding a mixture of a powdered magnetic material and a powdered infrared radiation emitting material, resin molding manufacturing methods have also been devised wherein powdered tourmaline, which is an infrared radiation and charged particle emitting material, is first given an insulating coating with a coupling agent, in order to particularly increase the effect of the charged particles (see JP-2001-126908-A).

Rare earth magnets are conductive metallic materials that almost completely reflect infrared radiation. Ferrite magnets are insulators, which are permeable by infrared radiation. For this reason, it is thought that the infrared radiation absorption loss resulting from the magnetic material is quite small, but as the functional groups associated with the basic main chains of the resin polymers have great infrared absorption capacity, the infrared radiation, which is emitted from infrared radiation emitting materials at the interior of the magnet as a result of activation by body heat, is absorbed within the resin and does not readily reach the surface of the composite magnet. Accordingly, unless the radiation capacity of the admixed infrared radiation emitting material is high, the effectiveness thereof is low. Consequently, there is a demand for materials having high infrared radiation emission capacities.

Furthermore, with regard to the body penetrating effect of the charged particles, charge generation is limited to the time up to the point at which a stable state is reached, and if the surface of the tourmaline, which is the piezoelectric/pyroelectric material, has been insulated, because it is difficult for the charged particles to pass through the insulating film, almost no effect can be expected. Furthermore, because the lifetime and mobility of charged particles in the bonding resin is not great, even those charged particles that do pass through the insulating film become trapped in the resin, so that even if charges are generated from tourmaline, the amount that reaches the surface of the human body is small.

Germanium is a semiconductor and therefore has high charged particle radiation capacity, and because the wavelength of the infrared radiation resulting from the semiconductor band structure is long, at 100 μm, the heating effect resulting from the infrared radiation is small. Consequently, substantially no synergetic effect can be expected as a result of penetration by infrared radiation and charges with conventional composite magnets using infrared radiation and charged particles.

### DISCLOSURE OF THE INVENTION

First aspect of the present invention is directed at improving the performance of a healthcare device using the conventional composite magnet described above or a surface coated composite magnet. That is to say, it is to an object of the present invention to provide a healthcare device which is fully capable of continuously providing a synergistic effect from magnetic force lines, infrared radiation and charged particles, causing the human body to be continuously penetrated by infrared radiation and charged particles while the healthcare device is being worn, without the effect of the infrared radiation and the charged particles penetrating the surface of the human body being limited in time.

Second aspect of the present invention is directed at providing a healthcare device which emits infrared radiation and charged particles more effectively when the healthcare device is being worn.

Third aspect of the present invention is directed at improving the performance of a conventional healthcare device using the synergistic effect of infrared radiation and charged particles described above. The healthcare device according to this aspect is still more desirable in that it achieves a synergistic effect with magnetic force lines by making combined use of a magnetic material. That is to say, it is an another object of the present invention to provide an economical healthcare device which fully achieves a synergistic effect from infrared radiation and charged particles by continuously penetrating the human body with infrared radiation and charged particles when the healthcare device is being worn, without the effect of the infrared radiation and charged particles penetrating the surface of the human body being limited in time.

### BRIEF DESCRIPTION OF THE DRAWINGS

FIG. 1 shows the infrared spectral radiance characteristics of the composite carbon particles of the present invention and tourmaline.

FIG. 2 is another infrared spectral radiance graph for SP3 structure carbon particles.

FIG. 3 is electrical resistance/temperature graph for SP3 structure carbon particles.

FIG. 4 is an infrared spectral radiance graph for the composite carbon articles of the present invention and tourmaline.

FIG. 5 is a schematic view of the present invention.

FIG. 6 is a graph comparing the charged particle emission capacity of SP3 carbon particles alone and a hybrid product.

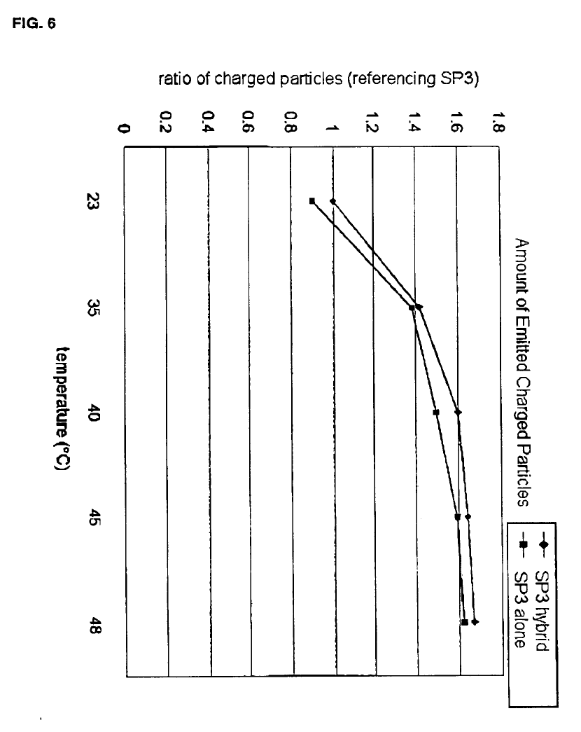

### DETAILED DESCRIPTION OF THE INVENTION

A first aspect of the present invention is characterized in that, in order to solve the problems mentioned above, a conductive composite carbon particle formed by shockwaves, having an SP3 diamond structure and an SP2 graphite structure (hereinbelow also referred to simply as an SP3 and SP2 composite carbon particle) is disposed at a face of a healthcare device that contacts the human body (referred to as the human body contact face, in the present specification) (claim 1).

Healthcare devices are commonly formed as bracelets or the like, made from metallic bands or nonmetallic bands. Accordingly, the conductive composite carbon particles described above are preferably disposed at the human body contact face of the metallic band or nonmetallic band of such a bracelet.

When a healthcare device configured in this manner is used by wearing it on the body, as a result of the heating effect due to body heat and the cooling effect due to the metallic band or the nonmetallic band at the human body contact face, a temperature difference is generated between the particles so that the effect of emitting infrared radiation and charged particles from the conductive composite carbon particles is maintained.

Modes of supporting the conductive composite carbon particles at the human body contact face of the healthcare device include modes wherein the conductive composite carbon particles are bound with resin bond or glass bond (claim 2), and modes wherein the conductive composite carbon particles are applied as a coating on the surface of a magnet, or applied as a coating on the surface of a magnet in the form of a mixture with a resin or with glass (claim 3). In the latter case, in addition to infrared radiation and charged particles being emitted from the conductive composite carbon particles, magnetic force lines are emitted in combination therewith. Furthermore, a mode is preferred wherein the conductive composite carbon particles are applied as a coating to the surface of a semiconductor thermoelectric element and a piezoelectric/pyroelectric element (claim 4). In this case, the combined emission levels of the infrared radiation and the charged particles are increased.

Furthermore, it is more preferred that a material, wherein the conductive composite carbon particles are mixed with magnetic material, piezoelectrtc/pyroelectric material and semiconductor material powders and molded, is disposed at the human body contact face (claim 5). In this case, the combined emission levels of magnetic force lines, infrared radiation and charged particles are increased.

It is preferred that the conductive composite carbon particles are provided on a band that generates a magnetic field with an external magnetic flux density of no greater than 400 G comprising a magnetic metallic material or a composite material wherein a magnetic powder is affixed to a fabric (claim 6).

In order to achieve the object described above, in the second aspect of the present invention, a carbon particle having an SP3 structure formed by shockwaves (hereinbelow also referred to simply as an “SP3 structure carbon particle”) is disposed at the human body contact face of a metallic band or nonmetallic band comprised by the healthcare device (claim 7).

When a healthcare device configured in this manner is used by wearing it on the human body, as a result of the heating effect due to body heat and the cooling effect due to the metal or the nonmetal comprised by the healthcare device at the human body contact face, a temperature difference is generated between the particles, whereby the strong effect of emitting infrared radiation and charged particles is continuously maintained while the healthcare device is being worn.

In order to provide a healthcare device with SP3 structure carbon particles, these SP3 structure carbon particles may be mixed with epoxy resin or a low melting point glass powder and applied as a coating to a metallic or nonmetallic part of the healthcare device, which contacts the human body, and then thermoset, or the SP3 structure carbon particles may be admixed with or affixed to fabrics or fibers (claim 8). In another method of use, the SP3 structure carbon particles may be mixed with resin or glass and applied as a coating on the surface of a magnetic material, or maybe integrally molded into products in the form of a mixed powder, which allows for a combined effect of infrared radiation, charged particles and magnetic force lines (claims 9 to 10).

One specific example of a method of producing the SP3 structure carbon particles is a method wherein a high-performance CB explosive is exploded in a sealed container so as to momentarily produce 2,000,000 atmospheres of pressure and several thousand degrees of heat, so as to form SP3 structure carbon particles, or a method wherein fine carbon powder, copper powder and the like are placed in a vessel and an explosive, which is placed thereupon, is ignited, so as to apply similar pressures and temperatures to the mixed powder product and change the crystalline structure of the carbon, whereafter the metal powder is dissolved with acid to produce the SP3 structure carbon particles. In the cooling process after producing these particles, the surface may be covered with a carbon film having an SP2 structure, but if necessary this SP2 structure carbon film can be removed with heated concentrated nitric acid or heated supercritical water. (See Eiji Osawa, Japan Nanonet Bulletin, pp. 10806/03/08 and Sumitomo Coal Mining Co, Ltd, Cluster Technology Research Group, 06/03/27) In the present invention, the SP2 structure carbon film is not absolutely necessary.

During the particle production process, impurities, and particularly nitrogen contained by the explosive, are included in carbon powder that is produced by the shockwave method, so that this tends to act as an N-type semiconductor. Furthermore, influences such as stresses within the particles due to the pressure during the explosion, disrupts the solid band structure so as to give the particles a 0.2 to 0.4 eV impurity level, causing the particles to be conductive. Furthermore, the present inventors discovered that, because the powder has a particular type of SP3 structure, the infrared radiation capacity and charged particle emission capacity thereof is five to ten times greater than that of conventional tourmaline and the like. Normal single crystal diamonds are almost perfect insulators, having a band gap of 5.5 eV and a resistivity of 10¹⁶Ω at normal temperatures, but the semiconductor SP3 structure carbon particles used in the present invention allow for resistivity values of approximately 10Ω to 10¹⁰Ω, depending on manufacturing conditions. Diamonds, which have a high resistivity near that of an insulator, have a low impurity level density, so that charges are not readily sufficiently excited to jump the band gap as a result of heating at the body heat level. Consequently, the charged particle emission effect is small, and the radiated light that is emitted when the excited charged particles fall back into the valance band is also small.

In addition, the SP3 structure carbon particles are preferably applied as a coating, in the form of a mixture with resin or the like, on the human body contact face of a healthcare device component comprising semiconductor thermoelectric elements, magnets or piezoelectric/pyroelectric material, or the SP3 structure carbon particles may be mixed with powders of the aforementioned materials and disposed in integrally formed composite magnet (claims 9 to 10). Specifically, such methods as making a hole in an oxide or rare earth magnet and filling the center with the particles, coating the surface of a metallic healthcare device that emits magnetic force lines with a mixture of the particles and an organic or inorganic bonding material, and coating with a composite spray or the like may be proposed. In some cases, the material of the present invention may be applied as a coating on the surface of the magnetic material.

As a result, in addition to the charged particle penetration effect, by exploiting the synergistic effect of infrared radiation and magnetic force lines, the healthcare effects on the body can be further improved.

Furthermore, the healthcare device may be formed as a band of a semihard magnetic material or fabric impregnated with a magnetic powder, which has good workability and an external magnetic field of no greater than 400 G, and the SP3 structure carbon particles may be used by affixing them to the surface of this band (claim 11). Healthcare devices that generate magnetic fields of 400 to 1500 G using ordinary magnetic bodies have strong magnetic fields and cannot be used on the arms or on body parts where they may influence cardiac pacemakers, but the healthcare device of this claim can be used on the arms or on body parts where they may influence cardiac pacemakers.

In order to solve the aforementioned problems, the third aspect of the present invention is such that SP3 semiconductor carbon particles are disposed at a human body contact face of a healthcare device, and the SP3 semiconductor carbon particles are excited by infrared radiation and charged particle energy emitted by a piezoelectric/pyroelectric material that is disposed therebehind, so as to increase the penetration effect of charged particles and infrared radiation in the 4 to 10 μm wavelength range, which is effective in warming the human body (claim 12). Preferably, the molded article containing the SP3 semiconductor carbon particles is no less than 10 μm thick. At less than 10 μm, few charged particles are generated and the effect of penetrating the human body is inferior.

Healthcare devices are commonly formed as bracelets and the like, which are made from metallic bands and nonmetallic bands. Accordingly, the semiconductor carbon particle molded product described above is preferably disposed at the human body contact face of a metallic or nonmetallic band such as a bracelet or the like, with the product molded from the plezoelectric/pyroelectric material powder is set therebehind.

When the healthcare device is used by wearing it on the human body, as a result of thermal excitation of the semiconductor carbon particles by body heat, charged particles and infrared radiation at wavelengths of 4 to 10 μm are generated at the human body contact face. The infrared energy generated by the piezoelectric/pyroelectric effect on the back face excites the SP3 semiconductor carbon particles on the front face, converting the wavelengths to infrared radiation with a wavelength of 4 to 10 μm. Few charged particles are generated by the product molded from plezoelectric/pyroelectric particles, but because the molded product is an insulator, they remain in the form of surface charge, so that the charged particles that are generated by the semiconductor carbon particles on the front face are moved to the human body by the electrical field, thus increasing the effect of penetrating the human body. When semiconductor carbon particles are used for the infrared radiation and charged particle emitting material, there is no change in the infrared radiation effect, but the charge generated by the semiconductor carbon particles is partially discharged into the metallic band, lowering the charged particle penetration effect, which is inefficient in terms of effective use of the material. Furthermore, because the cost of SP3 semiconductor carbon particles is roughly 100 times greater than that of piezoelectric/pyroelectric materials, there are also economic problems in terms of using SP3 semiconductor carbon particles for all of the molded components.

In terms of modes of supporting the SP3 semiconductor carbon particles at the human body contact face of the healthcare device, the SP3 carbon particles may be bound with resin bond or glass bond, and drip coated onto the molded piezoelectric/pyroelectric material and then thermoset (claim 13), or the SP3 carbon particles may be sprayed onto the molded piezoelectric/pyroelectric material. Productivity can be increased by other means wherein the carbon particles and the piezoelectric/pyroelectric materials are press-molded separately and then bonded.

According to the invention recited in claim 1, in order to make use of the charged particle and infrared radiation effect resulting from the charge that is generated by the temperature differential between the human body contact face and the air contact face of the healthcare device, which is caused by body heat, conductive composite carbon particles having an SP3 diamond structure and an SP2 graphite structure are used in place of tourmaline, which is a piezoelectric/pyroelectric material, thus allowing for continuous emission of charged particles and infrared radiation when the healthcare device is being worn, so as to greatly increase the body temperature raising effect, as compared with conventional products.

According to the invention recited in claim 2, the conductive composite carbon particles can be used by mixing them into a resin bond material or a glass bond material, which is applied to a surface of the healthcare device and hardened, allowing great flexibility in terms of usage modes.

According to the invention recited in claim 3, the conductive composite carbon particles are used by applying them as a coating on a surface of the healthcare device, whereby a small quantity of the conductive composite carbon particles is sufficient, which is highly advantageous in terms of cost.

According to the invention recited in claim 4, the conductive composite carbon particles are used by applying them as a coating to the surface of a semiconductor thermoelectric element and a piezoelectric/pyroelectric element, which increases the electric charge penetration effect, thus further increasing the effect on the human body.

According to the invention recited in claim 5, a powdered magnetic material and a powdered piezoelectric/pyroelectric material are mixed and integrally molded with a resin bond material or a glass bond material, which is excellent in terms of mass production characteristics. Moreover, in addition to the charge penetration effect, a synergistic effect can be expected from the magnetic force lines and the infrared radiation, thus further increasing the effect on the human body.

Next, according to the invention as recited in claim 6, a synergistic effect can also be expected if the healthcare device is formed using a magnetic metallic band (bracelet, ring or the like) or a band that has been impregnated with a magnetic powder, which emits an external magnetic field of no greater than 400 G. Furthermore, there are no limitations on the places in which such a device can be used. This is because the infrared radiation capacity and the charged penetration effect of SP3 and SP2 composite carbon particles is greater than in cases where tourmaline is used.

According to the invention as recited in claim 7, the charged particle penetration effect and the infrared radiation effect are based on charged particles in the carbon particles, which have an SP3 structure and which are excited by body heat, and on the electrical field generated by the temperature differential between the human body contact face and the air contact face of the healthcare device, whereby a continuous charge and infrared radiation effect can be expected when this healthcare device is being worn. Accordingly, the effect of increasing body temperature is greater than with conventional products.

According to the invention recited in claim 8, the SP3 structure carbon particles can be used by mixing them with fibers or affixing them to fibers, or by mixing them with resin or glass bond material, applying this to a surface of the healthcare device, and processing so as to harden this, allowing great flexibility in terms of usage modes.

According to the invention recited in claim 9, the SP3 structure carbon particles are used by applying them as a coating on a surface of the healthcare device, whereby a small quantity of the carbon powder is sufficient, which is highly advantageous in terms of cost.

According to the invention recited in claim 10, the SP3 structure carbon particles are mixed with a magnetic material powder and a piezoelectric/pyroelectric material powder and integrally molded with a resin bond material or a glass bond material, which is excellent in terms of mass production characteristics. Furthermore, in addition to the charge penetration effect, a synergistic effect can be expected from the magnetic force lines and the infrared radiation, thus further increasing the effect on the human body.

According to the invention as recited in claim 11, a synergistic effect can also be expected if the healthcare device is formed using a magnetic metallic band such as a bracelet or a ring or a band that has been impregnated with a magnetic powder, which emits an external magnetic field of no greater than 400 G. Furthermore, there are no limitations on the places in which such a device can be used. This is because of the great infrared radiation emission capacity and charge penetration effect resulting from the special semiconductor structure of the SP3 structure carbon particles.

According to the invention recited in claim 12, the product molded from SP3 carbon particles, which is disposed at the human contact face of the healthcare device, produces an effect of raising the temperature of the human body as a result of infrared radiation that is excited by body heat and an effect of penetrating the human body with generated charged particles. Furthermore, the amount of the expensive SP3 semiconductor carbon particles used can be reduced because the action of the charged particle emissions and the infrared radiation from the SP3 semiconductor carbon particles is increased as a result of an electrical field that is generated by the charge that is produced due to the temperature difference in the plezoelectric/pyroelectric material that is disposed behind the SP3 carbon particles.

According to the invention recited in claim 13, the SP3 carbon particles and piezoelectric/pyroelectric material particles are mixed with a resin bond material or a glass bond material, and this is used by embedding it in a metallic band that forms the healthcare device, allowing great flexibility in terms of usage modes.

According to the invention as recited in claim 14, an inexpensive material having good electrical insulation properties is used for the piezoelectric/pyroelectric material, whereby the charge penetration effect of the SP3 carbon particles resulting from the charge that is generated can be increased. Furthermore, the piezoelectric/pyroelectric material is press-molded into a predetermined shape which can be mounted on the healthcare device in advance, which is excellent in terms of mass production characteristics.

### Best Mode For Carrying Out The Invention

In a preferred mode of embodiment of the first aspect of the present invention, conductive composite carbon particles having an SP3 diamond structure and an SP2 graphite structure, formed by shock waves, are mixed with an epoxy resin, a low melting point glass powder or the like, which is the bonding material, this mixture is applied as a coating on to the human body contact portion of a metallic or nonmetallic band that forms the healthcare device and is thermoset (claim 2) or this mixture is applied as a coating on a magnet or a piezoelectric/pyroelectric element and this is thermoset (claim 3), whereby the magnetic force lines, semiconductor charge effect and infrared radiation emitting material effect are used at the same time.

Specific examples of methods for producing the conductive composite carbon particles having an SP3 diamond structure and an SP2 graphite structure (semiconductor and conductive particles) include (A) exploding a high-performance CB explosive in a sealed container so as to momentarily generate pressures of 2,000,000 atmospheres and temperatures of several thousand degrees, so as to form ultrafine diamond particles having a composite structure; (B) placing fine carbon powder, copper powder and the like in a sealed container, and igniting explosives that have been placed on top of these, so as to subject the powder mixture to similar pressures and temperatures, and after turning the carbon into diamond, dissolving the metal powder with acid, so as to produce particles having the structure described above (see Eijl Osawa, Japan Nanonet Bulletin, pp. 108, 2006.03.08 and Sumitomo Coal Mining Co, Ltd, Cluster Technology Research Group, 2006.03.27) These methods are referred to hereinafter as shockwave methods.

During the particle production process, impurities, and particularly nitrogen contained by the explosive, are included in diamond-like powder that is produced by the shockwave method, so that this tends to act as an N-type semiconductor; furthermore, as a result of stress within the particles and the like, due to the pressure at the time of the explosion, the band structure of the diamond is disturbed so that this is conductive; furthermore it has been found that, because the particles have a special SP3 and SP2 composite carbon structure, the infrared radiation and the charged particle emission is five to ten times greater than conventional products such as tourmaline or the like.

Normal diamonds are almost perfect insulators, having a band gap of 5.5 eV and a resistivity of 10¹⁶Ω at normal temperatures. Diamonds have a high resistivity near that of an insulator, so that charges are not readily sufficiently excited to jump the band gap as a result of heating at body heat levels, and thus there is no charged particle emission effect. Accordingly, the radiated light that is emitted when the excited charged particles fall back into the valance band is also small. As compared to this, the semiconductor SP3 and SP2 composite carbon particles used in the present invention are capable of achieving low resistivity values of approximately 10Ω to 10¹⁰Ω, depending on manufacturing conditions. The use of these SP3 and SP2 conducting composite carbon particles having low resistivity is the reason why a large charged particle emission effect is achieved by heating at the body temperature level.

In addition, the SP3 and SP2 composite carbon particles are preferably applied as a coating in the form of a mixture with resin or the like, on the human body contact face of a healthcare device component comprising semiconductor thermoelectric elements, magnets and pleoxoelectric/pyroelectric material, or the SP3 and SP2 composite carbon particles are preferably mixed with powders of the aforementioned materials and disposed in integrally formed composite magnet (claims 2 and 4). Specifically, such methods as making a hole in an oxide or rare earth magnet and filling the center with the particles, coating the surface of a metallic healthcare device that emits magnetic force lines with a mixture of the particles and an organic or inorganic bonding agent, or coating with a composite spray may be proposed.

In some cases, the SP3 and SP2 composite carbon particles may be applied as a coating on the surface of the magnetic material (claim 3).

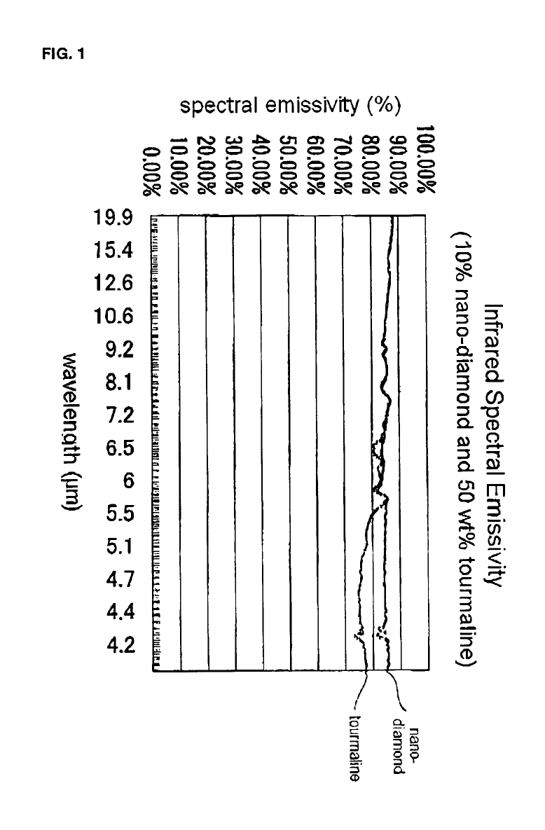

Consequently, in addition to the charged particle penetration effect, by exploiting the synergistic effect of infrared radiation and magnetic force lines, the healthcare effects on the body can be further improved. A comparison of the infrared radiation characteristics of the SP3 and SP2 composite carbon particles used in the healthcare device of the present invention and tourmaline, which are used in ordinary healthcare devices, is shown in FIG. 1. A mixture of 50 wt % of tourmaline in epoxy resin and a mixture of 10 wt % of ultrafine diamond particles in epoxy resin were each thermoset at 150° C. to produce samples S1 and S2, the infrared spectral radiations of which were measured in a 40° C. environment.

The ultrafine diamond particles constituted only ⅕ of the amount of tourmaline that was added, but a large amount of infrared radiation was emitted at 5 μm or less, which is mainly emitted from objects that have been heated to 200 to 40° C. Furthermore, a healthcare device may be formed as a band of a semihard magnetic material or fabric impregnated with the magnetic powder, which has good workability and an external magnetic field of no greater than 400 G, and the powder having the composite structure according to the present invention may be used by affixing this to the surface of this band (claim 6). Healthcare devices that generate electric fields of 400 to 1500 G using ordinary magnetic bodies cannot be used on body parts where they may influence cardiac pacemakers, but the healthcare device of the present invention can be used without influence on cardiac pacemakers.

In the first aspect of the present invention, in order to increase the infrared radiation emission effect and the charged particle penetration effect, a semifinished product, which is a liquid in which resin bond or glass bond and the composite powder are mixed, is used by pouring it into a hole which is made in the metallic band that forms the healthcare device and thermoset, or applying it as a coating to a surface of a magnet or the like, which is used in the healthcare device, and thermosetting it. In either case, in order to create a temperature differential from body heat and produce an infrared radiation effect and a charge particle penetration effect, the element that uses the SP3 and SP2 composite carbon particles is preferably disposed so as to be in contact with the human body. Consequently, it is possible to produce continuous infrared radiation and charged particle penetration effects. It is also possible to produce the coating by spraying techniques, without using a binder.

Tourmaline, morion and the like have conventionally been used as insulating infrared radiating materials, but the use of nano-diamonds, formed by the explosive force of CB explosives is most preferred. These nano-diamonds are semiconductor-like diamonds having a SP3 single crystal core that is coated with a thin graphite-like layer having a structure close to SP2 on the surface thereof. Because diamonds wherein a nitrogen component in the explosive is included as an impurity have special structures wherein the band structure is disturbed, the infrared radiation is great at all wavelengths, and the charged particle penetration effect resulting from heating is also great. An even greater effect can be expected from the combined use of indium antimonide for the semiconductor infrared radiating material, as it has high 100 μm infrared radiation and also has a high figure of merit as a thermoelectric element.

SP3 and SP2 composite carbon particles explosively formed by shockwave methods have a fine particle size of 3 to 100 nm as a result of this method, and the relative surface area per unit of weight is large, so that impact of the surface energy on the human body is great. The effect can be expected when these are used in healthcare devices. Furthermore, there is a tendency for nitrogen to be contained as an impurity, as a result of the explosive that is used, often resulting in N-type semiconductor characteristics and a broad electrical conductivity in the range of 10 to 10¹⁵. Thus, as compared to piezoelectric/pyroelectric materials such as tourmaline, which is in principle an insulator, the charge mobility and carrier density are great. Accordingly, the effect as a healthcare device is also great.

In one mode of embodiment of the second aspect of the present invention, the SP3 structure carbon particles were mixed with a resin or glass bonding agent, the liquid semifinished product was used to fill a hole that is made in a metallic band that forms the healthcare device, and this was thermoset. In another mode of embodiment, the aforementioned semifinished product was applied as a coating to the surface of a magnet or the like that was used in the healthcare device, and this was thermoset. In both cases, in order to generate excited carriers and electric fields resulting from the carrier temperature differential as a result of body heat, the element employing the SP3 structure carbon particles was disposed at the human body contact face of the healthcare device, so as to be in contact with the human body. Consequently, it was possible to produce a continuous infrared radiation and charged particle penetration effect. In other words, the infrared radiation effect and the charged particle penetration effect were greater than with conventional products.

For coating, it is also possible to use mixed spraying techniques, without using a binder. In cases where there is no need for a combined effect with magnetic force lines, the SP3 structure carbon particles may be used by mixing these with an adhesive material on the surface of a fabric to form a coating, or these may be mixed in with or affixed to fibers comprised by fabrics or the like.

Tourmaline, morion and the like have conventionally been used as insulating infrared radiating materials, but the use of carbon particles, formed by the explosive force of CB explosives and the like is most preferred. These carbon particles are normally manufactured as composite structure particles having a SP3 semiconductor structure core, the surface of which is coated with a thin graphite-like layer having a structure close to SP2, and depending on the application, the SP2 film can be dissolved and removed from the surface. In the applications of the present invention, the SP2 graphite layer shorts the charged particles that are generated, and is therefore unnecessary.

During the manufacturing process, the nitrogen component in the explosive is included as an impurity, resulting in a special structure in terms of the band-structure band gap, allowing for an impurity level having a low energy difference of 0.1 to 0.4 eV, and therefore the infrared radiation at wavelengths which are effective for warming the human body, as well as the charged particle generation effect resulting from heating, are both great.

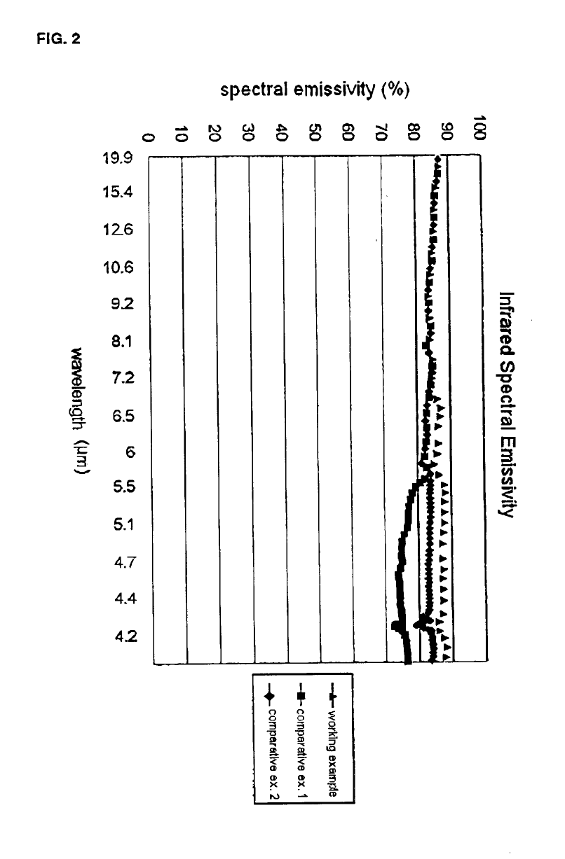

FIG. 2 shows the infrared radiation characteristics for SP3 structure carbon particles, composite carbon particles having an SP3 structure and an SP2 structure, and other materials such as tourmaline, that are normally used in healthcare devices. A mixture of 10 wt % of SP3 carbon particles in epoxy resin (working example 2), a mixture of 50 wt % of tourmaline in epoxy resin (comparative example 1) and a mixture of 10 wt % of composite carbon particles having an SP3 structure and an SP2 structure in epoxy resin (comparative example 2) were each thermoset at 150° C. to produce samples, the infrared spectral radiation of which were measured in a 40° C. environment.

In working example 2, even though the amount constituted only ⅕ of the amount in comparative example 1, a large amount of infrared radiation was emitted, principally at 4 to 10 μm, which is the wavelength emitted from objects that have been heated to 200 to 400° C. Furthermore, the spectral emissivity of the product of the present invention, wherein carbon particles having only an SP3 structure were used, was only approximately 3% greater than that of comparative example 2 as the result of the particle surfaces being covered in bonding resin, and it can be expected that a higher spectral emissivity can be achieved by using different types of coupling agents.

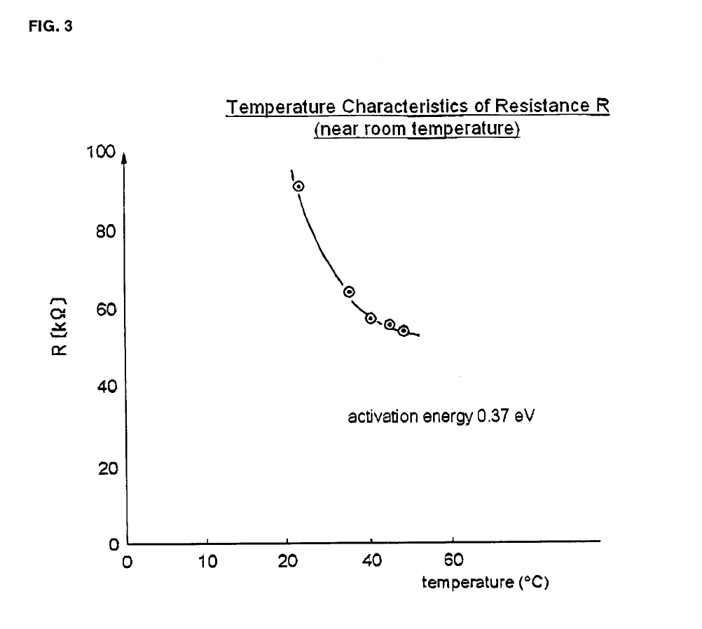

FIG. 3 shows the changes in resistance resulting from carriers generated by heating in the vicinity of body temperature. In terms of the measurement method: the carbon particles were press-molded to produce test pieces of 5 mm in diameter by 5 mm in thickness; copper electrodes and a thermocouple were attached: and the resistance and temperature were measured while heating with an electric heater. The electrical resistance was halved at temperatures of 23 to 48° C. This shows that the charged particles doubled as the result of heating. The activation energy calculated from the temperature coefficient of the electric resistance change is 0.37 eV, indicating that the carbon particles have semiconductor characteristics. An even greater effect can be expected from the combined use of germanium, indium antimonide and the like for the semiconductor infrared radiating material, as they have a high 100 μm infrared radiation and also a high figure of merit as thermoelectric elements.

Carbon particles having an SP3 structure, which are explosively formed by the shockwave method, have a fine particle size of 3 to 100 nm as a result of this method, and the relative surface area per unit of weight is large, so that impact of the surface energy on the human body is great. The effect can be expected when these are used in healthcare devices. Furthermore, there is a tendency for nitrogen to be contained as an impurity, as a result of the explosive that is used, resulting in N-type semiconductor characteristics and a broad electrical conductivity in the range of 10 to 10¹⁵. Thus, as compared to piezoelectric/pyroelectric materials such as tourmaline, which is in principle an insulator, the charge mobility and carrier density are great. Accordingly, the infrared radiation and charged particle emission are great, and thus the effect as a healthcare device is also great.

Next, the effect of increasing body temperature was measured and compared among healthcare devices in which composite carbon particles were used at differing ratios of SP3 structure and SP2 structure. If the effect of increasing temperature in a case where the ratio of content in SP3 structures to content in SP2 structures is 9 to 1 is taken as 1, the results of the measurements are as shown below.

| SP3 | SP2 | temperature rise ratio | manufacturer |
|---|---|---|---|
| 9 | 1 | 1 | made by company “S” in Japan |
| 7 | 3 | 0.6 | made in Russia |
| 5 | 5 | 0.4 | made in China |

The ratio of SP3 to SP2 is not a fundamental property that is dependent on the manufacturing source, but rather depends on the SP2 removal process.

In a preferred mode of embodiment of the third aspect of the present invention, the carbon particles having an SP3 semiconductor structure formed by shockwaves (SP3 semiconductor carbon particles) are mixed with epoxy resin or low melting point glass powder or the like, which is a bonding material, this mixture is applied as a coating onto the human body contact portion of a metallic or nonmetallic band that forms a healthcare device, in which a piezoelectric/pyroelectric material has been embedded, and thermoset (claim 8). Alternatively, these carbon particles may be mixed with the binding agent and then sprayed onto the aforementioned metallic or nonmetallic band.

Specific examples of methods for producing the SP3 semiconductor carbon particles include (A) exploding a high-performance CB explosive in a sealed container so as to momentarily generate pressures of 2,000,000 atmospheres and temperatures of several thousand degrees, so as to form ultrafine diamond particles having a composite structure of SP3 and SP2: (B) placing fine carbon powder, copper powder and the like in a sealed container, and igniting explosives that have been placed on top of these, so as to subject the powder mixture to similar pressures and temperatures, and after turning the carbon into diamond, dissolving the metal powder with acid so as to produce composite carbon particles having a diamond structure; and (C) if necessary, subsequently removing the SP2 graphite film from the surface with nitric acid or supercritcal water so as to produce the SP3 semiconductor carbon particles (see Eiji Osawa, Japan Nanonet Bulletin, pp. 108, 2006.03.08 and Sumitomo Coal Mining Co, Ltd, Cluster Technology Research Group, 2006.03.27)

During the particle production process, impurities, particularly nitrogen contained by the explosive, are included in diamond powder that is produced by the shockwave method, and tends to act as an N-type semiconductor; furthermore, as a result of stress within the particles and the like, due to the pressure at the time of the explosion, the band structure of the diamond is disturbed so that the impurity level density is high, making it conductive; furthermore, it has been found that the amount of infrared radiation in the 4 to 10 μm wavelength range from carriers excited as a result of body heat and the charged particle emission capacity is five to ten times greater than with conventional products such as tourmaline.

Normal diamonds are almost perfect insulators, having a band gap of 5.5 eV and a resistivity of 10¹⁶Ω at normal temperatures. Diamonds have a high resistivity near that of an insulator, so that charges are not readily sufficiently excited to jump the band gap as a result of heating at the body heat level. Consequently, the charged particle emission effect cannot be expected. Accordingly, the radiated light that is emitted when the excited charged particles fall back into the valance band is also small. As compared to this, the SP3 semiconductor carbon particles used in the present invention are capable of achieving low resistivity values of approximately 10² to 10⁶Ω, depending on manufacturing conditions. The gist of the present invention is that the use of these SP3 semiconductor carbon particles having low resistivity results in the achievement of a large charged particle emission effect with heating at body temperature levels. In addition, by disposing a piezoelectric/pyroelectric material therebehind, as a result of the infrared radiation and charged particles from this piezoelectric/pyroelectric material, the infrared radiation and charged particle emission capacity of the SP3 semiconductor carbon particles is amplified, which increases the health promoting effect.

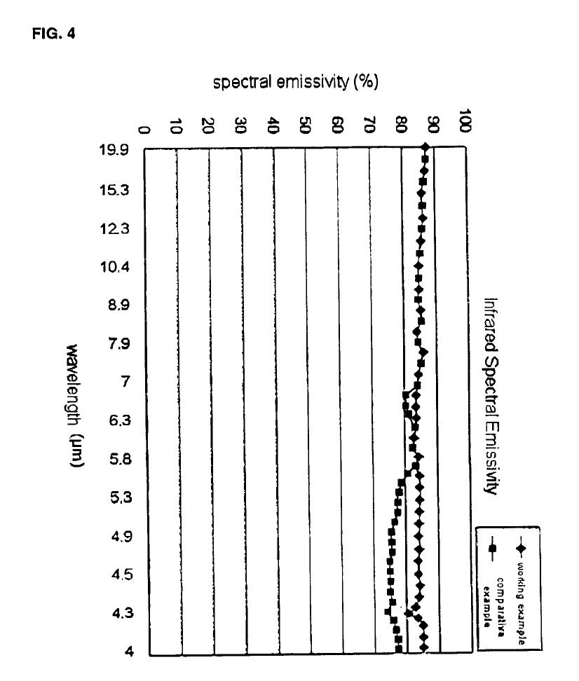

A comparison of the infrared radiation characteristics of the SP3 semiconductor carbon particles used in the present invention and tourmaline, which is used in ordinary healthcare devices, is shown in FIG. 4. The comparative example in FIG. 4 is such that a mixture of 50 wt % of tourmaline in epoxy resin is thermoset at 150° C. The working example is such that a mixture of 10 wt % of SP3 semiconductor carbon particles in epoxy resin is thermoset at 150° C. The infrared spectral radiance characteristics of both samples were measured in a 40° C. environment. The SP3 carbon particles constituted only ⅕ of the amount of tourmaline that was added, but a large amount of infrared radiation was emitted at 4 to 10 μm, which is mainly emitted from objects that have been heated to 200 to 400° C.

### WORKING EXAMPLE 1

A total of 20 holes, each having a diameter of 3 mm and a depth of 1.8 mm, were made in each of the human body contact faces of two pure titanium bracelets and two magnetic stainless steel bracelets that emit a magnetic field of 150 G, and after filling the holes in one of each of the types of bracelets with an epoxy resin mixture containing 50 wt % of tourmaline as a comparative example, and filling the holes in the other two bracelets with an epoxy resin mixture containing 20 wt % of nano-diamond as a working example of the present invention, these were dried for one hour at 150° C., and worn on an arm. After 15 minutes, the temperature rise was measured with a thermograph.

The results of the measurements described above are as shown in Table 1.

TABLE 1
Results of Measurement of Rise in Body Temperature

| | Temp. Rise ° C. | |
|---|---|---|
| | | Working Example |
| | Comparative Example | nano-diamond |
| Type of Healthcare Device | tourmaline (50 wt %) | (20 wt %) |
| pure titanium bracelet | 0.2 | 0.7 |
| magnetic stainless steel | 0.3 | 1.2 |
| bracelet | | |

It can be understood from the results of measurement of rises in body temperature given above that the ultrafine diamond particles are superior to tourmaline. The effect is particularly large when combined with a weak magnetic field.

### WORKING EXAMPLE 2

A total of 20 holes, each having a diameter of 3 mm and a depth of 1.8 mm, were made in each of the human body contact faces of two pure titanium bracelets and two magnetic stainless steel bracelets that emit a magnetic field of 150 G, and after filling the holes in one of each of the types of the bracelets with an epoxy resin mixture containing 50 wt % of tourmaline as a comparative example, and filling the holes in the other bracelet with an epoxy resin mixture containing 10 wt % of SP3 carbon particles, these were each dried for one hour at 150° C. to produce healthcare devices. These were each worn on the arm, and after 15 minutes the temperature rise was measured with a thermograph.

The results of the measurements described above are as shown in Table 2.

TABLE 2
Results of Measurement of Rise in Body Temperature

| | Temp. Rise ° C. | |
|---|---|---|
| | | Working Example |
| | Comparative Example | SP3 carbon particles |
| Type of Healthcare Device | tourmaline (50 wt %) | (10 wt %) |
| pure titanium bracelet | 0.2 | 0.6 |
| magnetic stainless steel | 0.3 | 1.0 |
| bracelet | | |

### WORKING EXAMPLE 3

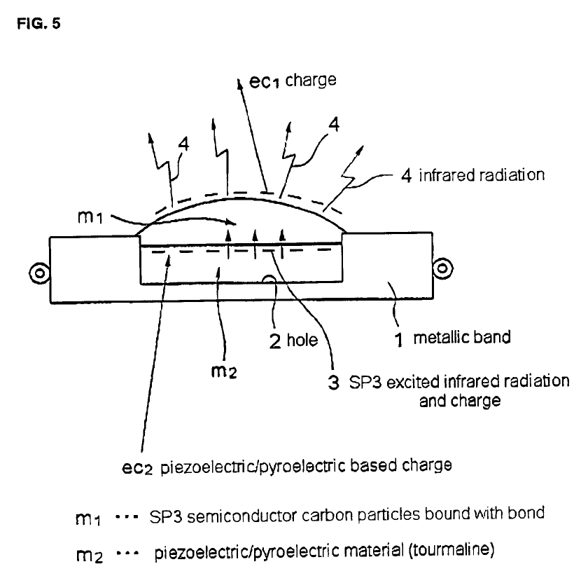

FIG. 5 shows a schematic view of a healthcare device according to the present invention. In the present invention, in order to increase the infrared radiation effect and the charged particle permeation effect, a semifinished product m₁, which is a liquid in which resin bond or glass bond and the SP3 semiconductor carbon particles are mixed, is poured into a hole 2 which is made, for example, in a titanium casing on the metallic band 1 that forms the healthcare device, and thermoset. At the bottom of this hole 2, a piezoelectric/pyroelectric material m₂, such as tourmaline, has been set in place in advance, either by the same method or in the form of a press-molded component. Both of the materials m₁, m₂ are activated by body heat and, as a result of the charges ec₁, ec₂ that are generated by excitation, infrared radiation and charged particles are generated, but the infrared radiation and charged particles 3 from the piezoelectric/pyroelectric material m₂, which is disposed at the bottom of hole 2, amplifies the infrared radiation 4, having a wavelength of 4 to 10 μm and the charged particle radiation effect from the SP3 semiconductor carbon particles. Accordingly, it is possible to reduce the amount of expensive SP3 semiconductor carbon particles used.

As a specific working example, 20 holes, each having a diameter of 3 mm and a depth of 1.8 mm, were made in the human body contact face of a pure titanium bracelet, and these were filled with 10 wt % of SP3 carbon particles and 90 wt % of epoxy resin. As another working example of the present invention, a hybrid structure was made by applying a 1 mm thick coating of an epoxy resin mixture containing 50 wt % of tourmaline on which a 0.8 mm thick coating of 90 wt % resin and 10 wt % SP3 carbon particles was applied. This was worn on a human body and, after 15 minutes, the rise in body temperature was measured using an infrared thermograph. Furthermore, the charged particle radiation and electricity generated by the healing were also measured. The amount of radiation at 23° C. with a component comprising 100% SP3 carbon particle powder was used as the standard for charged particle radiation amounts.

The results of the measurements described above are as shown below (t=thickness).

| third aspect product | SP3 hybrid | | body temperature rise |
|---|---|---|---|
| | | | 0.85° C. |
| (0.8 mm t + tourmaline 2 mm t) | | | |
| second aspect product | SP3 alone | 2.8 mm t | body temperature rise |
| | | | 0.80° C. |

The charged particle radiation curves resulting from heating of the product according to the third aspect of the present invention (SP3 hybrid) and product according to the second aspect (SP3 carbon particles alone) are shown in FIG. 3. There is almost no difference between the two in terms of body temperature rise effect and charged particle emission effect, but the material costs for the product of the present invention are approximately one third of those of the comparative product.

The amount of infrared radiation in the 4 to 10 μm range, which is effective for raising body temperature, is determined by the surface area of the final surface of the SP3 molded product, and is the same in both cases. In this working example, if the thickness of the molded SP3 and resin mixture product is less than 10 μm, the amount of charged particles and infrared radiation from the SP3 carbon particles is reduced.

From the foregoing measurement results it is understood that the healthcare device using the SP3 carbon particles in the hybrid structure of the third aspect of the present invention is inexpensive to manufacture but the human body temperature rise effect is substantially the same as that with a component comprising 100% SP3 carbon particles. This fact also indicates that the present invention is industrially useful.

If the product of the present invention is used in combination with a magnet, a synergistic effect is produced from magnetic force lines, infrared radiation and charged particle penetration effects.

### INDUSTRIAL APPLICABILITY

A healthcare device according to the present invention, which makes use of the infrared radiation heating effect and the charged particle penetration effect resulting from body heat heating of composite carbon particles having an SP3 diamond structure and an SP2 graphite structure formed using shock waves, a healthcare device according to the present invention, which makes use of the infrared radiation heating effect and the charged particle penetration effect resulting from body heat heating by applying a hybrid effect from a semiconductor SP3 carbon particle having an SP3 structure primarily comprising carbon formed using shockwaves, a healthcare device according to the present invention, which makes use of the infrared radiation heating effect and the charged particle penetration effect resulting from body heat heating of these particles, or a healthcare device according to the present invention, which makes use of the combined action of magnetic force lines on the human body, can be used in the form of necklaces, bracelets, rings, anklets, undergarments, socks, stomach bands, sheets, pillows and bedclothes as required, in addition to which they can also be used as medical devices for animals. As pets often have higher body temperatures than humans, a particularly good effect can be expected. In particular, there is a large effect when combined with magnetic fields of no greater than 400 G, which were found to be without effect in the past, allowing for use near electronic medical equipment that prohibits the use of magnetic bodies, such as cardiac pacemakers, which is industrially useful.

1. A healthcare device comprising conductive composite carbon particles, having an SP³ diamond structure and an SP² graphite structure, formed by shockwaves, and which are disposed at a human body contact surface.

2. The healthcare device recited in claim 1, wherein the conductive composite carbon particles are used bound with resin bond or glass bond.

3. The healthcare device recited in claim 1, wherein the conductive composite carbon particles are used in the form of a coating on a surface of a magnet or in the form of a mixture with resin bond or glass bond that coats a surface of a magnet.

4. The healthcare device recited in claim 1, wherein the conductive composite carbon particles are used in the form of a coating on a surface of a semiconductor thermoelectric element and a piezoelectric/pyroelectric element.

5. The healthcare device recited in claim 1, wherein the conductive composite carbon particles are mixed with magnetic material, piezoelectric/pyroelectric material and semiconductor material powders, molded, and disposed at the human body contact face.

6. A healthcare device comprising the conductive composite carbon particles recited in claim 1, 2, 3, 4 or 5 in a band that generates a magnetic field with an external magnetic flux density of no greater than 400 G, which is formed from a metallic magnetic member or a composite material wherein magnetic powder is affixed to a fabric.

7. A healthcare device comprising carbon particles having an SP3 structure formed by shockwaves, and a metallic or nonmetallic band, said composite carbon particles being disposed at a human body contact face of said band.

8. The healthcare device recited in claim 7 wherein the carbon particles having an SP3 structure formed by shockwaves are mixed with a resin, a high molecular weight polymer fiber or glass or affixed to the surface of a fiber.

9. The healthcare device recited in claim 7 wherein the carbon particles having an SP3 structure formed by shockwaves are applied as a coating on the surface of a magnet, a semiconductor thermoelectric element or a piezoelectric/pyroelectric element.

10. The healthcare device recited in claim 7 wherein the carbon particles having an SP3 structure formed by shockwaves are mixed with magnetic material, piezoelectric/pyroelectric material and semiconductor material powders and molded.

11. A healthcare device comprising the carbon particles having an SP3 structure formed by shockwaves recited in any one of claims 8 to 10 at the interior circumferential face of a band that generates a magnetic field with an external magnetic flux density of no greater than 400 G, which is formed from a metallic magnetic member or a composite material wherein magnetic powder is affixed to a fabric.

12. A hybrid type healthcare device comprising carbon particles having an SP3 semiconductor structure formed by shockwaves and plezoelectric/pyroelectric particles, the carbon particles having said SP3 semiconductor structure being disposed at a human body contact face.

13. The healthcare device recited in claim 12, further comprising a metallic band, the carbon particles having an SP3 semiconductor structure and the piezoelectric/pyroelectric particles, being bound with resin bond or glass bond and embedded in said metallic band.

14. The healthcare device recited in claim 12 or 13, wherein at least one of tourmaline, PZT or quartz is used as the piezoelectric/pyroelectric material.
